(19) United States
(12) Patent Application Publication
(10) Pub. No.: US 2024/0253524 A1
(43) Pub. Date: Aug. 1, 2024

(54) METHOD FOR FAST CHARGING ELECTRIC VEHICLE BATTERY

(71) Applicant: FORD GLOBAL TECHNOLOGIES, LLC, Dearborn, MI (US)

(72) Inventors: Minghong Liu, Northville, MI (US); Kent Snyder, Dearborn, MI (US)

(21) Appl. No.: 18/104,350

(22) Filed: Feb. 1, 2023

(51) Int. Cl. B60L 58/20; B60L 50/60; B60L 55/00; B60L 58/12; H02J 7/00; H02J 7/34

(52) U.S. Cl. CPC B60L 58/20; B60L 50/60; B60L 55/00; B60L 58/12; H02J 7/00711; H02J 7/00712; H02J 7/342

(57) ABSTRACT

A controller, responsive to a command to fast charge a traction battery, initiates a discharge pulse of the traction battery that charges an auxiliary battery, and following the discharge pulse, initiates a charge of the traction battery such that a voltage of the traction battery decreases to a peak minimum value during the discharge pulse and continually increases immediately after the peak minimum value without dwelling at a constant value to preclude rest of the traction battery between the discharge pulse and charge of the traction battery.

### TECHNICAL FIELD

The present disclosure relates to a system and method for charging a battery of an electric vehicle.

### BACKGROUND

Electric vehicles rely on one or more traction batteries providing electric energy to an electric machine for propulsion. The traction battery may include a rechargeable battery such as a lithium-ion battery, which may be subject to fast charging.

### SUMMARY

A vehicle power system includes a traction battery, an auxiliary battery, and a controller. The controller, responsive to a command to fast charge the traction battery, initiates a discharge pulse of the traction battery that charges the auxiliary battery, and following the discharge pulse, initiates a charge of the traction battery such that a voltage of the traction battery decreases to a peak minimum value during the discharge pulse and continually increases immediately after the peak minimum value without dwelling at a constant value to preclude rest of the traction battery between the discharge pulse and charge of the traction battery.

A vehicle control system includes a controller that, responsive to a state of charge of an auxiliary battery exceeding a threshold, discharges the auxiliary battery to a traction battery, and responsive to a request to charge the traction battery, commands a discharge pulse current of the traction battery that charges the auxiliary battery and then commands a charge current of the traction battery.

A method includes, responsive to a command to fast charge a traction battery, initiating a discharge pulse of the traction battery that charges an auxiliary battery, and following the discharge pulse, initiating a charge of the traction battery such that a voltage of the traction battery decreases to a peak minimum value during the discharge pulse and continually increases immediately after the peak minimum value without dwelling at a constant value to preclude rest of the traction battery between the discharge pulse and charge of the traction battery.

### BRIEF DESCRIPTION OF THE DRAWINGS

FIG. 1 illustrates an example block topology of an electrified vehicle illustrating drivetrain and energy storage components.

FIG. 2 illustrates a current diagram during a fast charging process.

FIG. 3 illustrates a discharge circuit diagram of one embodiment of the present disclosure.

FIG. 4 illustrates a discharge circuit diagram of another embodiment of the present disclosure.

FIG. 5 illustrates a flow diagram of a process for discharging the traction battery.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes a system and method for charging a battery on an electrically powered vehicle.

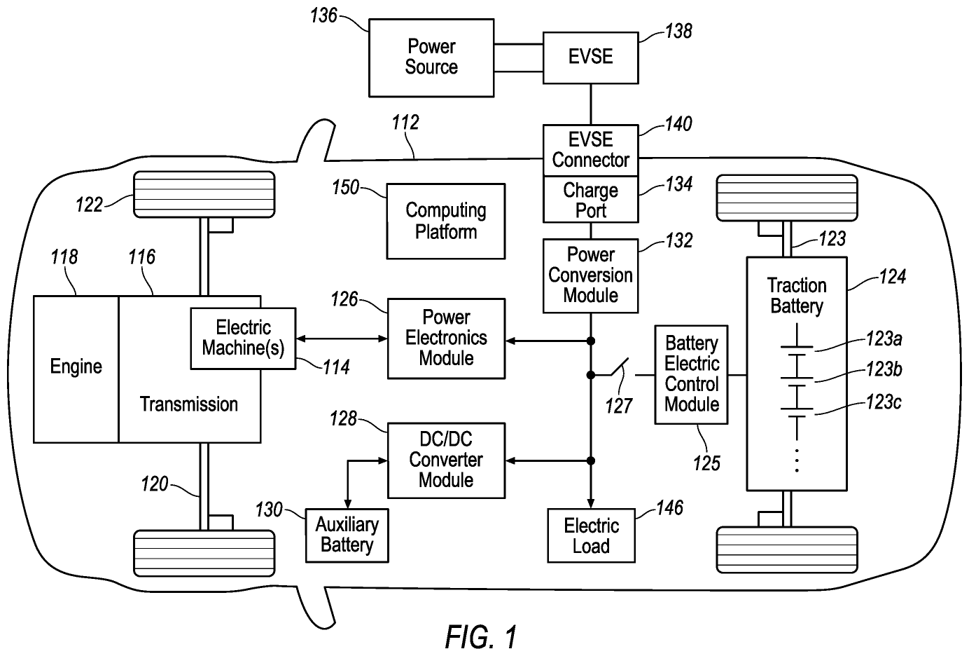

FIG. 1 illustrates a plug-in hybrid-electric vehicle (PHEV). A plug-in hybrid-electric vehicle 112 may comprise one or more electric machines (electric motors) 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 may provide propulsion and deceleration capability when the engine 118 is turned on or off. The electric machines 114 may also act as generators and may provide fuel economy benefits by recovering energy that would be lost as heat in the friction braking system. The electric machines 114 may also reduce vehicle emissions by allowing the engine 118 to operate at more efficient speeds and allowing the hybrid-electric vehicle 112 to be operated in electric mode with the engine 118 off under certain conditions.

A traction battery or battery pack 124 stores energy that may be used by the electric machines 114. The vehicle battery pack 124 may provide a high voltage DC output. The traction battery 124 may include a plurality of battery cells 123 connected in series and/or parallel to provide the high voltage DC outputs. The traction battery 124 may be electrically coupled to one or more battery electric control modules (BECM) 125. The BECM 125 may be provided with one or more processors and software applications configured to monitor and control various operations of the traction battery 124. The traction battery 124 may be further electrically coupled to one or more power electronics modules 126. The power electronics module 126 may also be referred to as a power inverter. One or more contactors 127 may isolate the traction battery 124 and the BECM 125 from other components when opened and couple the traction battery 124 and the BECM 125 to other components when closed. The power electronics module 126 may also be electrically coupled to the electric machines 114 and provide the ability to bi-directionally transfer energy between the traction battery 124 and the electric machines 114. For example, a traction battery 124 may provide a DC voltage while the electric machines 114 may operate using a three-phase AC current. The power electronics module 126 may convert the DC voltage to a three-phase AC current for use by the electric machines 114. In a regenerative mode, the power electronics module 126 may convert the three-phase AC current from the electric machines 114 acting as generators to the DC voltage compatible with the traction battery 124. The description herein is equally applicable to a pure electric vehicle. For a pure electric vehicle, the hybrid transmission 116 may be a gear box connected to the electric machine 114 and the engine 118 may not be present.

In addition to providing energy for propulsion, the traction battery 124 may provide energy for other vehicle electrical systems. A vehicle may include a DC/DC converter module 128 that converts the high voltage DC output of the traction battery 124 to a low voltage DC supply that is compatible with other low-voltage vehicle loads. An output of the DC/DC converter module 128 may be electrically coupled to an auxiliary battery 130 (e.g., 12V battery).

The vehicle 112 may be a battery electric vehicle (BEV) or a plug-in hybrid electric vehicle (PHEV) in which the traction battery 124 may be recharged by an external power source 136. The external power source 136 may be a connection to an electrical outlet. The external power source 136 may be an electrical power distribution network or grid as provided by an electric utility company. The external power source 136 may be electrically coupled to electric vehicle supply equipment (EVSE) 138. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled may transfer power using wireless inductive coupling.

One or more electrical loads 146 may be coupled to the high-voltage bus. The electrical loads 146 may have an associated controller that operates and controls the electrical loads 146 when appropriate. Examples of electrical loads 146 may be a heating module, an air-conditioning module, or the like.

The various components discussed may have one or more associated controllers to control and monitor the operation of the components. The controllers may communicate via a serial bus (e.g., Controller Area Network (CAN)) or via discrete conductors. A system controller 150 may be present to coordinate the operation of the various components. It is noted that the system controller 150 is used as a general term and may include one or more controller devices configured to perform various operations in the present disclosure. For instance, the system controller 150 may be programmed to enable a powertrain control function to operate the powertrain of the vehicle 112. The system controller 150 may be further programmed to enable a telecommunication function with various entities (e.g. a server) via a wireless network (e.g. a cellular network).

The system controller 150 and/or BECM 125, individually or combined, may be programmed to perform various operations with regard to the traction battery 124. The traction battery 124 may be a rechargeable battery made of one or more rechargeable cells 123 (e.g. lithium-ion cells). During the fast charging processes, limits due to ionic transfer rate (concentration polarization) may be exceeded, which may result in lithium deposition on the anode surface of the battery cell. These effects may limit intercalation of lithium ions into the inter-planes of the graphite anode, and may lead to lithium plating or lithium dendrite formation at the anode surface. To counteract the polarization effect, a periodical discharge pulse may be introduced during the fast charging. The discharge current may counteract the polarization effect for better ion insertion into the graphite layer, and therefore reduce the risk of lithium plating and/or reduced cell degradation. The present disclosure proposes a charging system and associated methods adapted to employ an improved fast charging process for facilitating an improved battery cell cycle life, as well as other potential benefits.

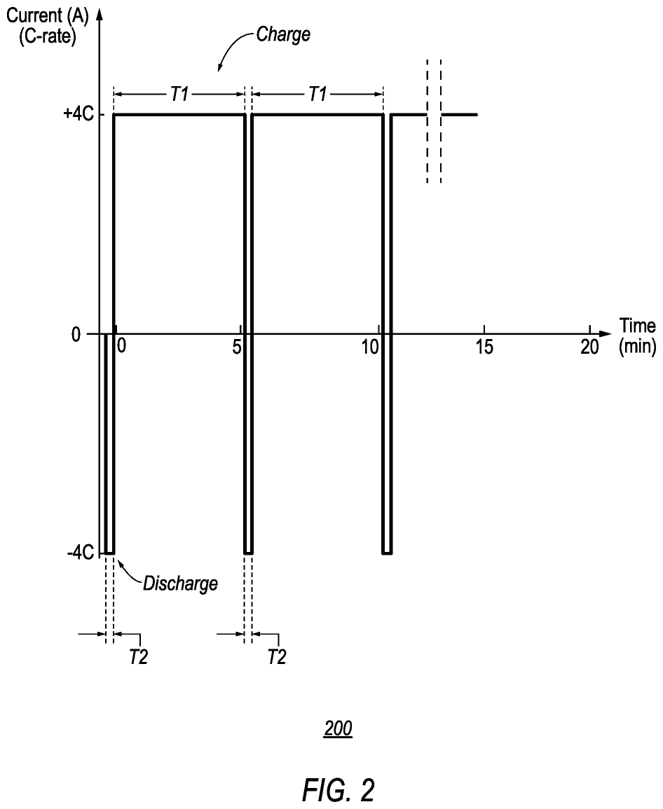

Referring to FIG. 2, an example current diagram 200 during fast a charging process of one embodiment of the present disclosure is illustrated. As discussed above, the high rate charging current increases the charging speed of the traction battery 124. Referring to the current diagram 200, the horizontal axis represents the time in the unit of minutes and the vertical axis represents the charging/discharging current in the unit of C-rate during the charging process. The charging current may be applied for a first time period T1 and the discharging current may be applied for a second time period T2. In general, the first time period T1 may be significantly longer than the second time period T2. As illustrated in the example with reference to the diagram 200, the first time period T1 for charging may be about 5 minutes and second time period T2 for discharging may be about 10 seconds. Both the charging and discharging current may be about 4 C. The relationship between the first time period T1 and the second time period T2 may be represented by the following equation:

$$0.25 * T 1 \leq T 2 \leq 0.00028 * T 1 \qquad ( 1 )$$

It is noted that the magnitude of both the time and current illustrated with reference to the diagram 200 is merely an example and the present disclosure is not limited thereto. Any applicable magnitude of the time and current may be used under essentially the same concept. It is further noted that although the charging current and the discharging current illustrated with reference to the diagram 200 is the same, the present disclosure is not limited thereto. In one or more alternative examples, the discharging current during the second time period T2 may be more or less than the charging current during the first time period T1.

The charging operation and the discharging operation described above may be repeated by alternating between applying the discharge pulse current for the second time period T2 followed by applying the charging current for the first time period T1. This alternating pattern of applying the discharging pulse current followed by the charging current may be performed until the voltage of the battery cells 123 reaches a predefined threshold voltage indicative of the battery cells being charged.

In the present disclosure, the first time period T1 during which the charging current is applied may immediately follow the second time period T2 during which the traction battery 124 is pulse discharged without a resting period (e.g. a period during which the traction battery is not subject to discharge current or charge current) in between. The voltage of the traction battery 124, as a result of the discharge pulse current, may decrease to a peak minimum value during the second time period, and then continuously increase immediately after the peak minimum value without dwelling at a constant value since the charging current is immediately applied to the traction battery 124 following the discharge pulse current. The voltage of the traction battery 124 may continue to increase during the first time period T1 until the following second period T2 is reached.

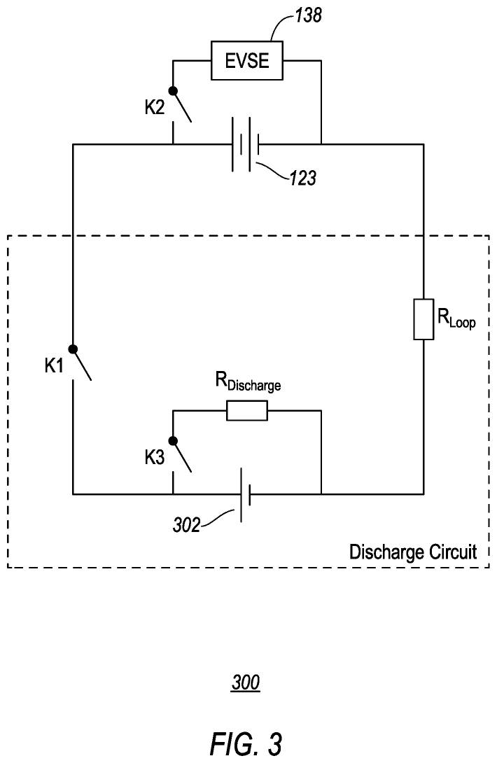

The present disclosure, among other things, proposes a discharge circuit and a method for operating the circuit for accommodating the discharging current during the fast charging process. Referring to FIG. 3, an example discharge circuit diagram 300 of one embodiment of the present disclosure is illustrated. With continuing reference to FIGS. 1 and 2, the discharge circuit 300 may be connected in parallel with one or more traction battery cells 123 and configured to receive the discharge current from the traction battery cells 123 as a discharging source. The discharge circuit 300 may include a low-voltage battery 302 connected in parallel to the traction battery cells 123 via a first switch K1 and a loop resistor R_{Loop}. The first switch K1 may be configured to connect and disconnect the discharging source cells 123 and the low-voltage battery 302. The loop resistor R_{Loop} may be connected in the discharging circuit loop and configured to dissipate a part of the discharging current to prevent a current surge during the discharging. The low-voltage battery 302 may be configured to have a lower voltage compared with the one or more traction battery cells 123 such that the discharging current with a higher voltage may be charged into the low-voltage battery 302.

Depending on the configuration of the discharge circuit 300, the low-voltage battery 302 may be implemented in various manners. For instance, the lower-voltage battery 302 may include one or more rechargeable battery cells. Alternatively, the lower-voltage battery 302 may include one or more super capacitors. The low-voltage battery 302 may be implemented as a separate component dedicated to the discharge circuit 300. Alternatively, the low-voltage battery 302 may be implemented without dedicated power storage devices but integrated with other components of the vehicle 112. As a few non-limiting examples, the low-voltage battery 302 may be implemented using the auxiliary battery 130. Alternatively, the low-voltage battery 302 may be implemented via a power storage device integrated with one or more components of the vehicle 112 such as a battery/capacitor of the electric load 146 to achieve essentially the same power storage goal.

As discussed above, the source 123 of discharging current may include one or more traction battery cells 123 in the present example. In one example, the source 123 may include only one traction battery cell having a voltage ranging from 2.5V to 4.2V. In this case, the low-voltage battery 302 may be configured at a voltage ranging from 1.2V to 1.7V which is lower than the voltage of the discharging source 123. Alternatively, the source 123 may include a plurality of traction battery cells 123 connected in series resulting in a higher voltage of the discharging source in the circuit. In this case, the low-voltage battery 302 may be configured to include a plurality of batteries/cells correspondingly. In a further alternative example, both the discharge source 123 and the low-voltage battery 302 may be implemented via traction battery 124. The battery cells 123 may be divided into a majority portion having a higher voltage operating as the discharge source 123 and a minority portion having a lower voltage operating as the low-voltage battery 302. In this example configuration, the connection between the plurality of cells 123 of the traction battery 124 may be adjusted to adapt to different operations of the vehicle 112. When the vehicle 112 is being used and the traction battery 124 discharges electricity to power the electric machine 114, the battery cells 123 may be connected in series to provide a high voltage. When the vehicle 112 is parked and the traction battery 124 is being charged under the fast charging process, the connections between the plurality of cells 123 within the traction battery 124 may be adjusted to enable the majority/minority portion division. In other words, the traction battery 124 may reconfigure the internal cell connections dividing the cells 123 into the majority portion configured to receive the fast charging current during the first time period T1, and the minority portion configured to receive the discharging current from the majority portion during the second time period T2.

The discharging circuit 300 may be implemented at various locations of the vehicle system. With reference to FIG. 1, in one example, all or parts of the discharging circuit 300 may be implemented inside the traction battery 124. In an alternative example, all or parts of the discharging circuit 300 may be implemented on the vehicle 112 outside the tradition battery 124. In a further alternative example, all or parts of the discharging circuit 300 may be implemented on the EVSE 138 outside the vehicle 112.

Referring to FIG. 3, the one or more traction battery cells 123 may be connected to the EVSE via a second switch K2. During the charging period T1 of the fast charging process when the charging current is received from the EVSE 138, the second switch K2 may close to allow the traction battery cells 123 to receive the charging current from the EVSE. During the discharging period T2 of the fast charging process, the second switch K2 may open to disconnect the traction battery cells 123 from the EVSE 138.

The discharging circuit 302 may further include a discharging resistor R_{Discharge} connected in parallel to the low-voltage battery 302 via a third switch K3. The third switch K3 remains open such that the discharging resistor R_{Discharge} is disconnected from the rest of the discharging circuit 300 by default. When the state of charge (SOC) of the low-voltage battery 302 is above a threshold indicative of being charged and the remaining capacity of the low-voltage battery 302 is insufficient to accommodate the next discharging current, the third switch K3 may close connecting the low-voltage battery 302 with the discharging resistor R_{Discharge} to dissipate the electric charge from the low-voltage battery 302 such that the low-voltage battery 302 has sufficient capacity to accommodate the upcoming discharging current.

In an alternative example, the discharge circuit 300 may be further configured to reversely discharge the electric energy of the low-voltage battery 302 back to the traction battery cells 123 when the SOC of the low-voltage battery 302 is above the threshold. To enable the reverse discharge, a power converter (not shown) may be connected between the low-voltage battery 302 and the traction battery cells 123 and configured to boost the voltage of the electric charge from the low-voltage battery to facilitate the reverse discharge.

Operations of the switches K1, K2, K3 may be individually or collectively controlled via one or more of the vehicle system. For instance, each of the switches may include a control terminal in communication with the BECM 125, system controller 150, power conversion module 132 as well as other controllers associated with the vehicle 112. Additionally or alternatively, if the discharge circuit is fully or partially implemented via the EVSE 138, operations of the switches may be further controlled by one or more controllers off-board the vehicle 112. For instance, the switches may be controlled via one or more controllers associated with the EVSE 138 and/or a remote server.

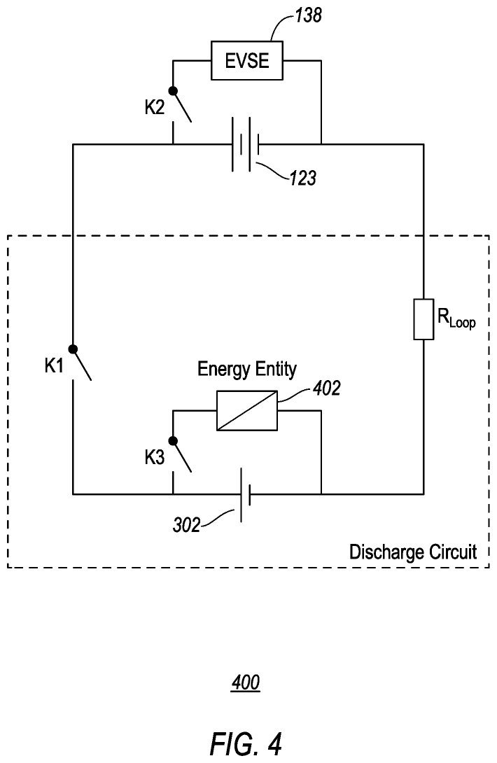

Referring to FIG. 4, an example discharge circuit diagram 400 of another embodiment of the present disclosure is illustrated. Different from the discharge circuit 300 illustrated with reference to FIG. 3, the discharge circuit 400 in the present example may include an energy entity 402 on-board or off-board the vehicle 112 in addition to or in lieu of the discharge resistor R_{Discharge}. The energy entity 402 may be configured to communicate electric energy with the low-voltage battery 302 and/or the traction battery cells 123. For instance, the energy entity 402 may be a home energy storage device off-board the vehicle and configured to receive the electric charge from the low-voltage battery 302 responsive to the SOC of the low-voltage battery 302 being above a threshold. Alternatively, the energy entity 402 may be associated with the grid/utility provider. In other words, the discharge circuit 300 may be configured to send the power from the low-voltage battery back to the grid in exchange for credits.

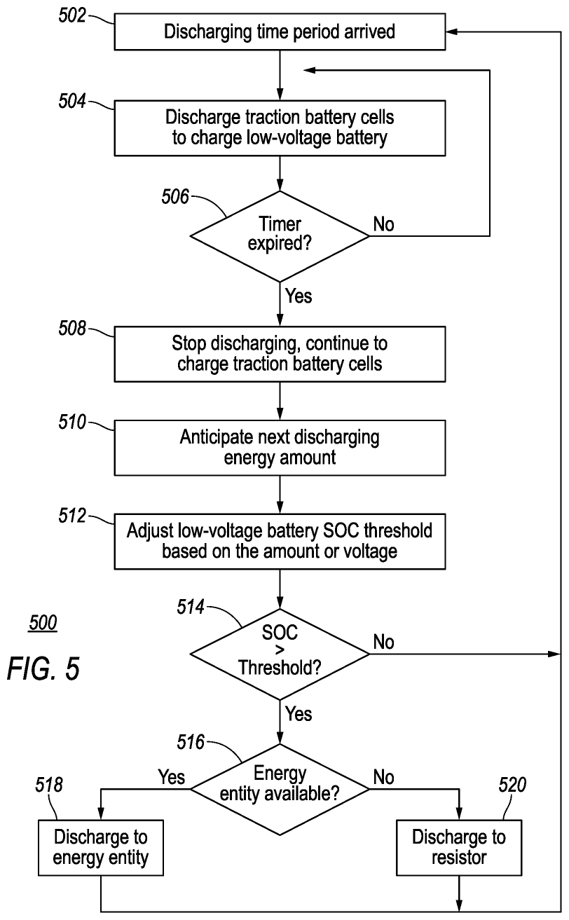

Referring to FIG. 5, an example flow diagram of a process 500 for operating the discharging circuit to discharge the vehicle traction battery is illustrated. With continuing reference to FIGS. 1-4, the process 500 may be individually or collectively implemented via one or more of the BECM 125, the system controller 150, power conversion module 132, EVSE 138 and/or other applicable controllers. For simplicity, the following description will be made with reference to the BECM 125 although the present disclosure is not limited thereto. Responsive to detecting the discharging time period T2 has arrived at operation 502, the BECM 125 operates the traction battery 124 and the discharging circuit 300, 400 to discharge electric energy from the traction battery cells 123 to charge the low-voltage battery 302. The discharging process continues until a discharging timer indicates the expiration of the discharging time period T2 at operation 506. At operation 508, responsive to the restarting of the charging time period T1, the BECM 125 stops the discharging and continues to charge the traction battery cells 123 via the EVSE 138. At operation 510, the BECM anticipates a total amount of energy to be discharged from the traction battery cells. The anticipated amount of energy may be made by various factors. For instance, the charging and discharging period T1, T2 may be of a fixed or variable length. In case that the variable length is used, the BECM 125 may anticipate the total amount using the length of the variable discharging time period T2. In another example, the BECM may adjust the discharging power voltage of the traction battery cells by varying the current and voltage during the discharge based on factors such as battery temperature, the severeness of the polarization effect, battery degradation status or the like. The BECM 125 may anticipate the total amount based on the discharging power.

At operation 512, the BECM 125 adjusts the low-voltage battery SOC threshold based on the amount or voltage as anticipated. At operation 514, the BECM verifies if the current SOC of the low-voltage battery 302 is above the threshold indicative of the low-voltage battery 302 having insufficient capacity to accommodate the total amount of energy to be released from the traction battery cells 123 during the next discharging period T2. If the answer is no, indicative of the low-voltage battery 302 having sufficient capacity, the process returns to operation 502 and waits for the next discharging time period T2. Otherwise, the process proceeds to operation 516 in preparation to discharge the low-voltage battery. At operation 516, the BECM 125 verifies if the energy entity 402 is available to receive the extra power from low-voltage battery 302. In general, discharging the extra charge to the energy entity 402 is preferred to minimize energy wastes. If the answer is yes, indicative of the energy entity being available, the process proceeds to operation 518 and the BECM 125 releases electric power from the low-voltage battery 302 to the energy entity. Otherwise, if the energy entity 402 is unavailable, the process proceeds to operation 520 and the BECM 125 discharges electric power from the low-voltage battery 302 via the discharging resistor R Discharge.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words controller and controllers may be interchanged herein.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle power system comprising:
a traction battery;
an auxiliary battery; and
a controller programmed to, responsive to a command to fast charge the traction battery, initiate a discharge pulse of the traction battery that charges the auxiliary battery, and following the discharge pulse, initiate a charge of the traction battery such that a voltage of the traction battery decreases to a peak minimum value during the discharge pulse and continually increases immediately after the peak minimum value without dwelling at a constant value to preclude rest of the traction battery between the discharge pulse and charge of the traction battery.

2. The vehicle power system of claim 1, wherein the controller is further programmed to discharge the auxiliary battery to charge the traction battery.

3. The vehicle power system of claim 1 further comprising a resistor, wherein the controller is further programmed to, responsive to a state of charge of the auxiliary battery being greater than a threshold, discharge the auxiliary battery across the resistor.

4. The vehicle power system of claim 1, wherein the controller is further programmed to, responsive to a state of charge of the auxiliary battery being greater than a threshold, discharge the auxiliary battery to an electrical grid.

5. The vehicle power system of claim 1, wherein the controller is further programmed to execute a plurality of consecutive cycles each including a discharge pulse of the traction battery followed by a charge of the traction battery.

6. The vehicle power system of claim 1, wherein the traction battery is a lithium-based battery.

7. A vehicle control system comprising:
a controller programmed to,
responsive to a state of charge of an auxiliary battery exceeding a threshold, discharge the auxiliary battery to a traction battery, and
responsive to a request to charge the traction battery, command a discharge pulse current of the traction battery that charges the auxiliary battery and then command a charge current of the traction battery.

8. The vehicle control system of claim 7, wherein the controller is further programmed to, responsive to the state of charge exceeding the threshold, discharge the auxiliary battery across a resistor.

9. The vehicle control system of claim 7, wherein the controller is further programmed to, responsive to the state of charge exceeding the threshold, discharge the auxiliary battery to an electrical grid.

10. The vehicle control system of claim 7, wherein the controller is further programmed to execute a plurality of cycles each including a discharge pulse current command followed by a charge current command.

11. The vehicle control system of claim 7, wherein the traction battery is a lithium-based battery.

12. A method comprising:
responsive to a command to fast charge a traction battery, initiating a discharge pulse of the traction battery that charges an auxiliary battery, and following the discharge pulse, initiating a charge of the traction battery such that a voltage of the traction battery decreases to a peak minimum value during the discharge pulse and continually increases immediately after the peak minimum value without dwelling at a constant value to preclude rest of the traction battery between the discharge pulse and charge of the traction battery.

13. The method of claim 12 further comprising discharging the auxiliary battery to charge the traction battery.

14. The method of claim 12 further comprising, responsive to a state of charge of the auxiliary battery being greater than a threshold, discharging the auxiliary battery across a resistor.

15. The method of claim 12 further comprising, responsive to a state of charge of the auxiliary battery being greater than a threshold, discharging the auxiliary battery to an electrical grid.

16. The method of claim 12, wherein the traction battery is a lithium-based battery.

17. The method of claim 12 further comprising executing a plurality of consecutive cycles each including a discharge pulse of the traction battery followed by a charge of the traction battery.
